(19) United States
(12) Patent Application Publication
(10) Pub. No.: US 2017/0121047 A1
(43) Pub. Date: May 4, 2017

(54) CONTAINER AND PREFORM WITH NECK FINISH

(71) Applicant: PepsiCo, Inc., Purchase, NY (US)

(72) Inventors: Carlos Hernan MARINA, Deerfield Beach, FL (US); Sameer Kirti TALSANIA, Chicago, IL (US); Jean-Claude BAUMGARTNER, Cheyres (CH); Eric Jay BRUNELLA, Sylvania, OH (US); Thierry Jean Robert FABOZZI, Geneva (CH); Tucker H. FORT, New York, NY (US); Dana Marie LASHAWAY, Les Evouettes (CH); Wayne Allen POSEY, Toledo, OH (US); Morris Elijah WORDEN, IV, New York, NY (US)

(21) Appl. No.: 15/336,401

(22) Filed: Oct. 27, 2016

Related U.S. Application Data
(60) Provisional application No. 62/248,708, filed on Oct. 30, 2015.

(51) Int. Cl. B65D 1/02; B29C 49/00; B29C 49/42; B65D 85/72

(52) U.S. Cl. CPC B65D 1/023; B65D 85/72; B29C 49/0078; B29C 49/4205; B29C 2049/0089; B29K 2067/00

(57) ABSTRACT

A container is provided with a cylindrical sidewall. A top flange projects from the cylindrical sidewall in a first direction by a first distance. A bottom flange projects from the sidewall in the first direction by a second distance that is less than the first distance. The top flange and the bottom flange extend circumferentially around the sidewall. A gap is formed between the top flange and the bottom flange.

### CROSS-REFERENCE TO RELATED APPLICATION

The present application claims priority to U.S. Provisional Patent Application No. 62/248,708 filed on October 30, 2015, which is incorporated herein in its entirety by reference thereto.

### BACKGROUND

Field

The present disclosure relates to containers.

Brief Summary

In some embodiments, a container is provided. The container comprises cylindrical sidewall, a top flange projecting from the sidewall in a first direction by a first distance, a bottom flange projecting from the sidewall in the first direction by a second distance that is less than the first distance, and a gap between the top flange and the bottom flange. The top flange extends circumferentially around the sidewall and the bottom flange extends circumferentially around the sidewall.

In some embodiments, top flange comprises a bottom surface, the bottom flange comprises a top surface, and the gap is formed between the bottom surface of the top flange and the top surface of the bottom flange.

In some embodiments, the gap spans at least 1.5 millimeters. In some embodiments, the gap extends circumferentially around the sidewall. In some embodiments, the gap between the top flange and the bottom flange remains constant around the circumference of the cylindrical sidewall.

In some embodiments, the difference between the first distance and the second distance is at least 1.5 millimeters.

In some embodiments, the top flange comprises a top surface that forms an outermost surface of the container. In some embodiments, the top surface includes a circular raised portion formed by an upwards projection of the top surface.

In some embodiments, the container does not comprise threads.

In some embodiments, the first direction is towards an exterior of the container. In some embodiments, the container further comprises a base projecting from the sidewall in a second direction, where the second direction is towards an interior of the container. In some embodiments, the base extends further from the sidewall than the bottom flange. In some embodiments, the bottom flange and the base are coplanar.

In some embodiments, the material forming the sidewall, the top flange, the bottom flange, and the base weighs less than 3 grams. In some embodiments, the material forming the sidewall, the top flange, the bottom flange, and the base weighs less than 2.5 grams.

In some embodiments, the container further comprises a body portion, a shoulder portion connected to the body portion, and a neck portion extending from the shoulder portion. The neck portion comprises the cylindrical sidewall, the top flange, the bottom flange, and the gap.

In some embodiments, the top flange includes a top surface comprising a circular raised portion, and the container further comprises a seal attached to circular raised portion.

In some embodiments, the container further comprises a cap disposed over the neck portion, the cap comprising an engagement portion to engage with the top flange.

In some embodiments, the container is a bottle. In some embodiments, the container is a cartridge for holding a beverage ingredient.

In some embodiments, a preform is provided. The preform comprises a moldable body portion and a neck portion. The neck portion comprises a cylindrical sidewall, a top flange extending from the sidewall, a bottom flange extending from the sidewall, and a gap between the top flange and the bottom flange. The top flange and the bottom flange extend circumferentially around the sidewall.

In some embodiments, the preform is configured to accommodate a gripper of a blow-molding machine between the top flange and the bottom flange.

### BRIEF DESCRIPTION OF THE DRAWINGS

FIG. 1 is a side view of a container with a neck portion according to some embodiments.

FIG. 2A is an up-close front view of the neck portion of the container as shown in FIG. 1.

FIG. 2B is a back view of the neck portion shown in FIG. 2A.

FIG. 2C is a left side view of the neck portion shown in FIG. 2A.

FIG. 2D is a right side view of the neck portion shown in FIG. 2A.

FIG. 2E is a schematic representation of a lead angle and a helix angle of a threaded structure.

FIG. 3 is a top view of a neck finish according to some embodiments.

FIG. 4 is a cross-sectional view of the neck finish shown in FIG. 3 at line A-A.

FIG. 5A is another cross-sectional view of the neck finish shown in FIG. 3 at line A-A.

FIG. 5B and FIG. 5C show representations of the angle change of the side surface of top flange according to some embodiments.

FIG. 6 is up-close view of area A in the neck finish of FIG. 5A.

FIG. 7A is front view of a container comprising a cap according to some embodiments.

FIG. 7B is a cross-sectional view of a neck finish with a seal according to some embodiments.

FIG. 8 is a side view of another container according to some embodiments.

FIG. 9 is a side view of a preform with a neck portion according to some embodiments

FIG. 10A is a side view representation of the interaction between a preform and a gripper according to some embodiments.

FIG. 10B is a schematic top view of the gripper shown in FIG. 10A.

### DETAILED DESCRIPTION OF THE INVENTION

Consumable products are sometimes packaged and provided to consumers in hermetically sealed containers. The containers protect the product during shipping and allow for the hermetic storage of perishable contents during the product's shelf life. These containers may be manufactured through a blow-molding process that forms a preform into a final container that is suitably shaped to store the underlying content.

The preform used in a blow-mold process is generally injection molded and includes a neck finish and a moldable body portion. During the blow-molding process, the moldable body portion is bi-axially stretched in an oven using a mold to form the final container's shape. The neck finish is not stretched and is used to support and center the preform in the mold. For example, in a two-stage process, the neck finish may have supporting features that enable the preform to be transferred with grippers out of the oven, into the mold, and out of the mold. Thus, supporting features may contribute to the efficient manufacturing of containers using a blow-mold process.

Despite the benefits of such supporting features, the addition of supporting features to a neck finish can be cost-prohibitive because of the need for additional raw materials. For example, a neck finish made of polyethylene terephthalate (PET) with supporting features may weigh at least 4 grams, requiring more PET than a neck finish without supporting features. This makes neck finishes with supporting features more expensive to make. In some instances, it may lead to an undesirable waste of resources.

Some embodiments of the present invention include lightweight neck finishes that may be used in the blow-molding process. The neck finishes described herein (and the containers and preforms with those neck finishes) are structurally configured to accommodate the blow-mold process while using only a limited amount of raw material. The resulting structure is not only lightweight and less costly to manufacture, but also enables simpler and more convenient handling in the overall manufacturing process of the preform and final container.

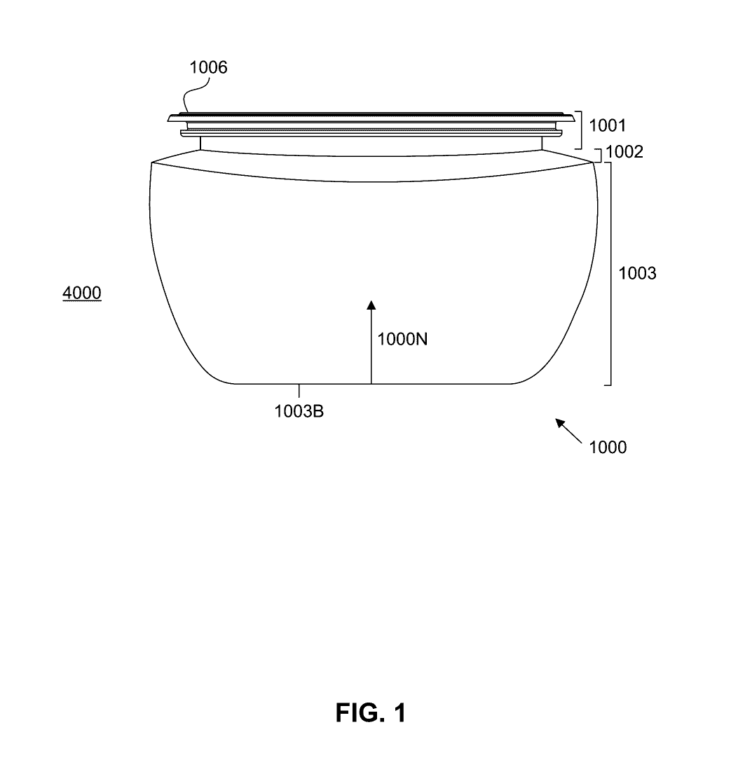

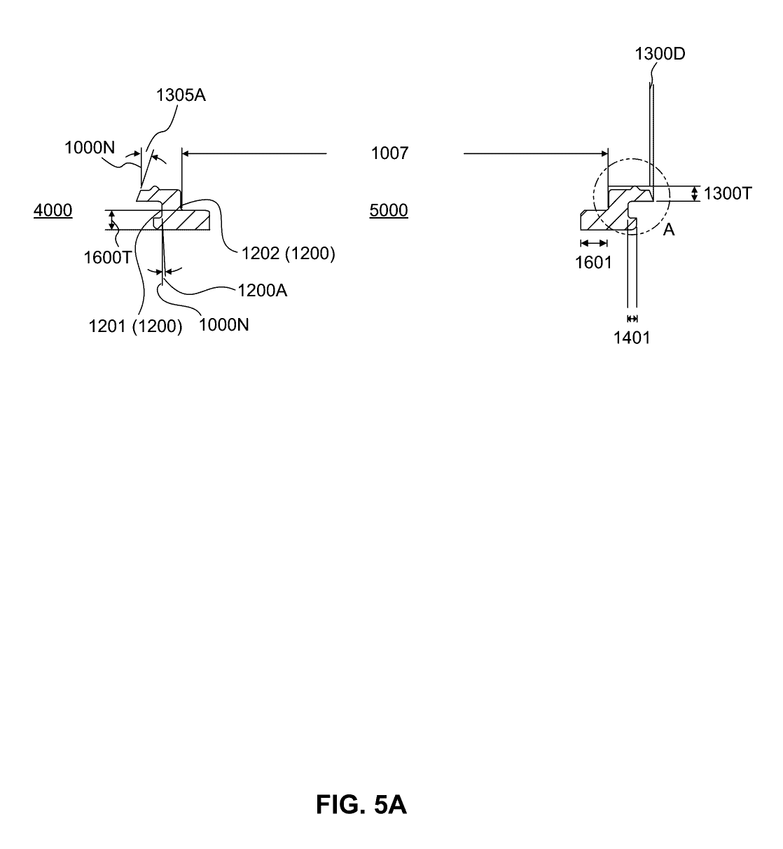

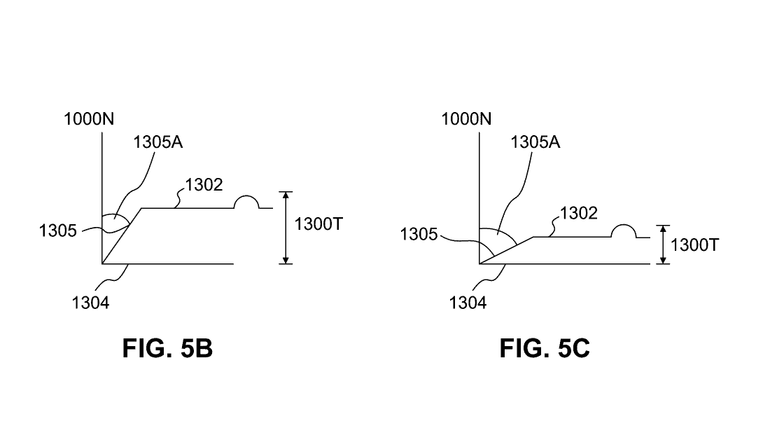

In some embodiments, and as shown in FIG. 1, a container 1000 includes a neck portion 1001, a shoulder portion 1002, and a body portion 1003. Body portion 1003 retains the underlying consumable content and has a bottom 1003B upon which container 1000 rests when placed on a surface. Shoulder portion 1002 is connected to body portion 1003 and neck portion 1001 extends from shoulder portion 1002. Neck portion 1001 includes a container opening 1007, as shown in FIG. 5A, that allows access to the interior of the container 1000. A longitudinal axis 1000N extends from bottom 1003B. Axis 1000N is normal (perpendicular) to the general plane of bottom 1003B and will be referred to as a reference axis in describing the surface angles of container 1000 below.

Container 1000 may be any vial that is suitable for holding a consumable product. In some embodiments, container 1000 is made of PET (polyethylene terephthalate), but other suitable flexible and resilient materials may be used, including, but not limited to, plastics such as PEN (polyethylene naphthalate), bioplastics such as PEF (polyethylene furanoate), and other polyesters.

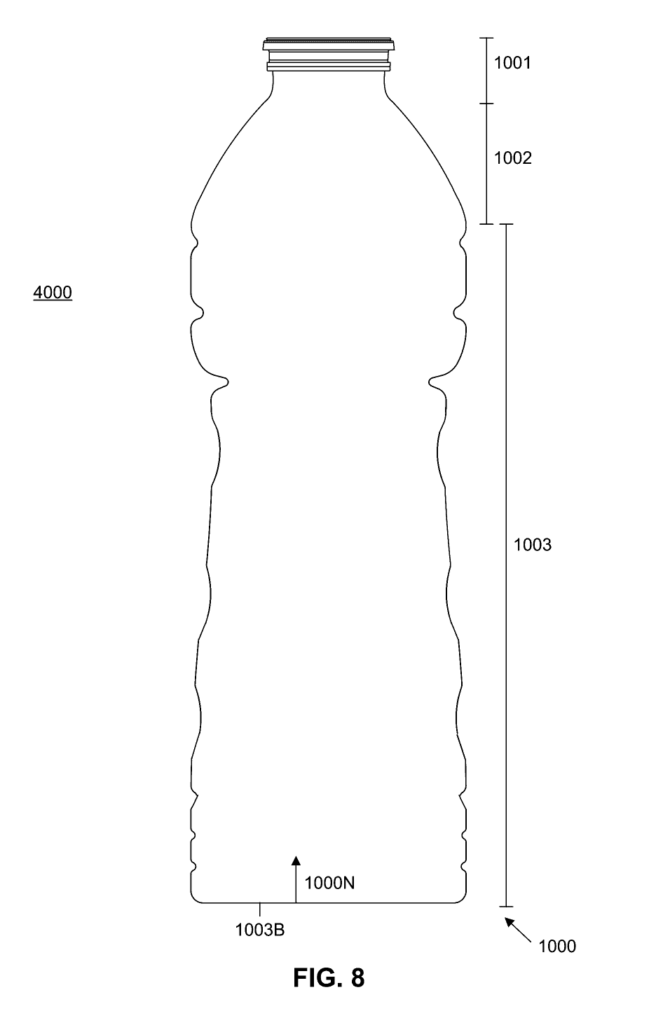

In some embodiments, and as shown in FIG. 1, container 1000 is a cartridge for holding a beverage ingredient. This beverage ingredient may be a liquid or a powder that is mixed together with another liquid (e.g., water) to create a beverage for consumption. In some embodiments, and as shown in FIG. 8, container 1000 is a bottle for holding consumable beverages such as soft drinks, water, juices, and energy drinks. While the containers 1000 shown in FIGS. 1 and 8 have certain shapes and sizes for shoulder and body portions 1002 and 1003, other shapes and sizes are also envisioned. Specifically, the shapes and sizes used for the body portion 1003 and shoulder portion 1002 may depend on the amount of the consumable product to be stored and the packaging needs of the product. For example, in some embodiments, container 1000 may be suitably shaped to store foods such as yogurt, cottage cheese, or cream. These products may include a body portion 1003 having a horizontal cross-section that is rectangular in shape rather than circular shapes shown in FIGS. 1 and 8.

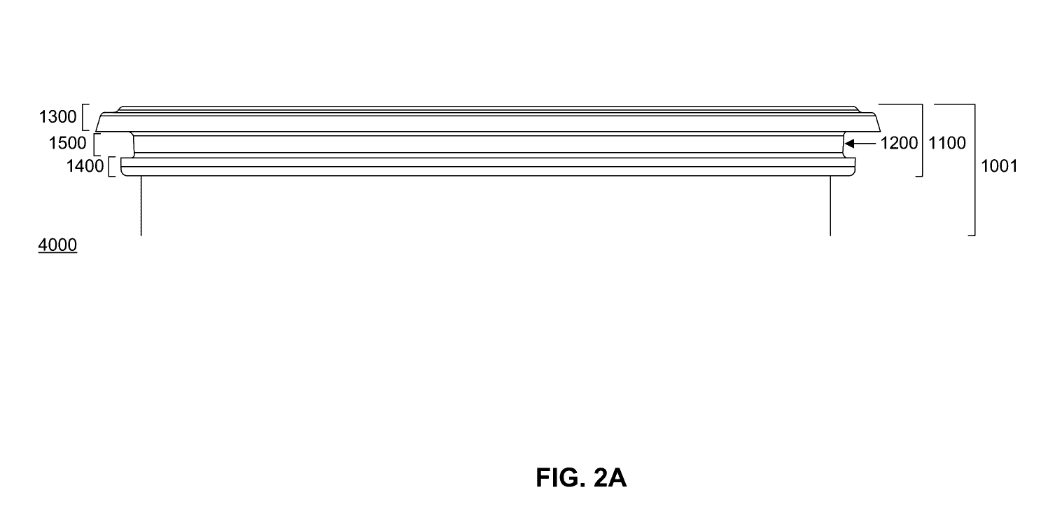

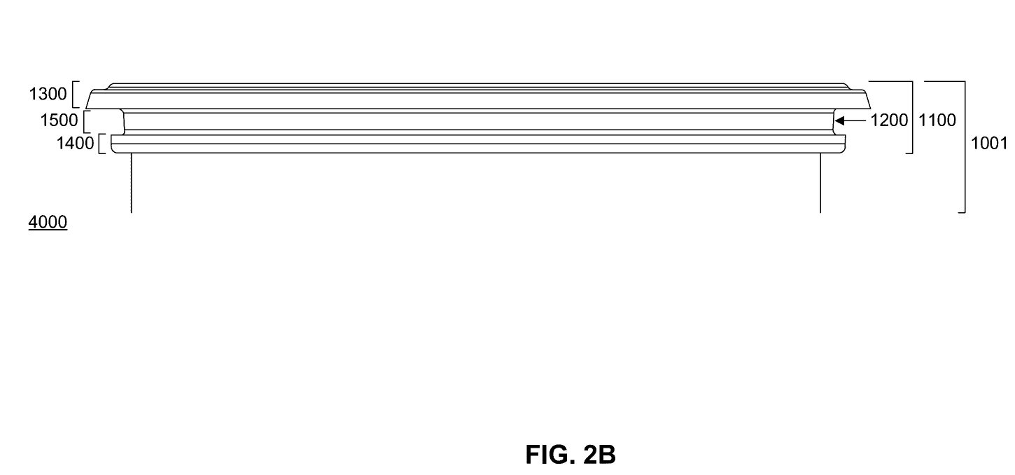

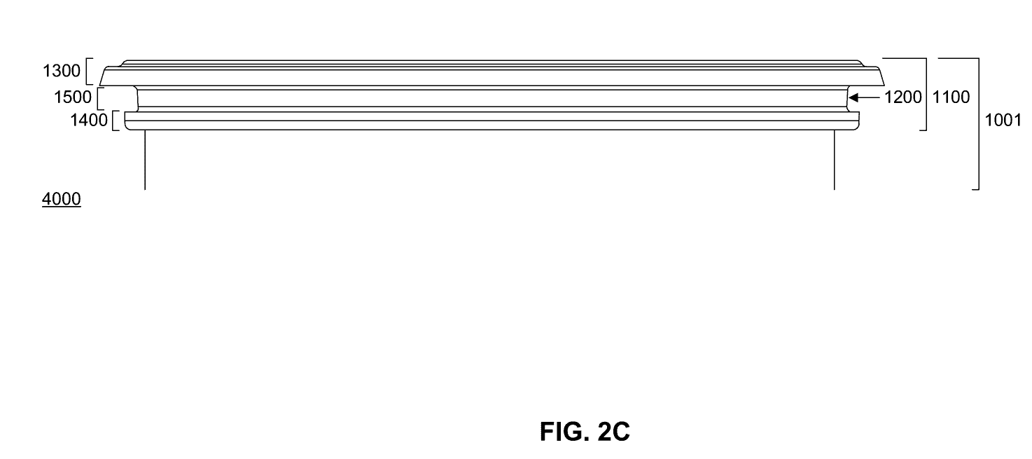

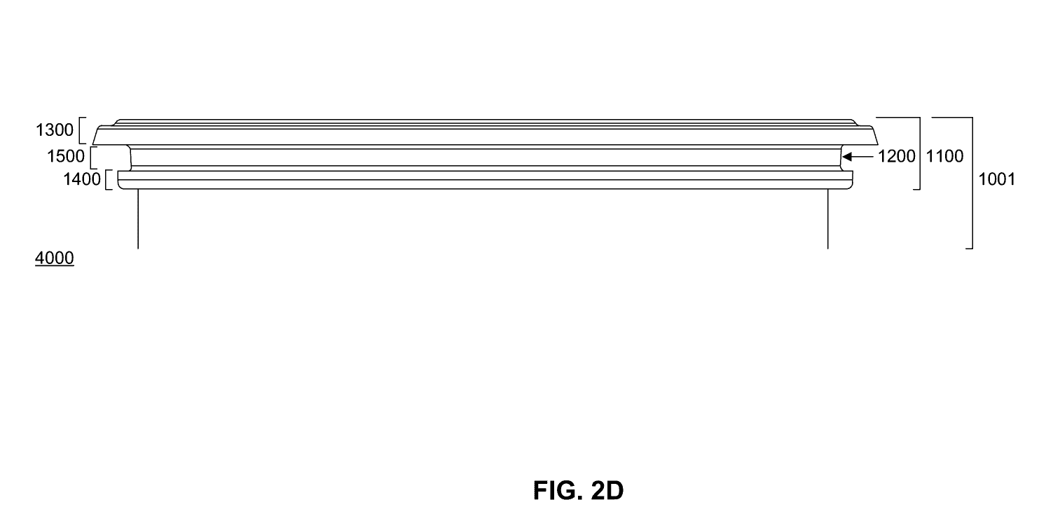

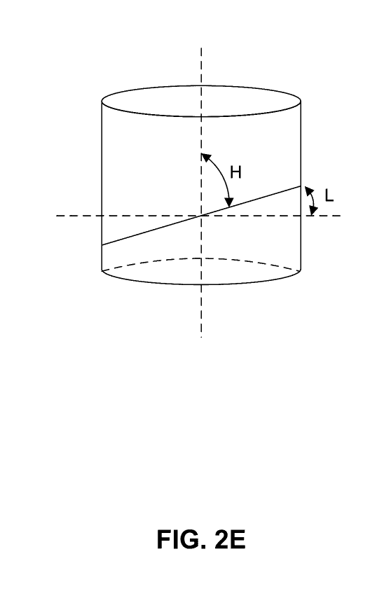

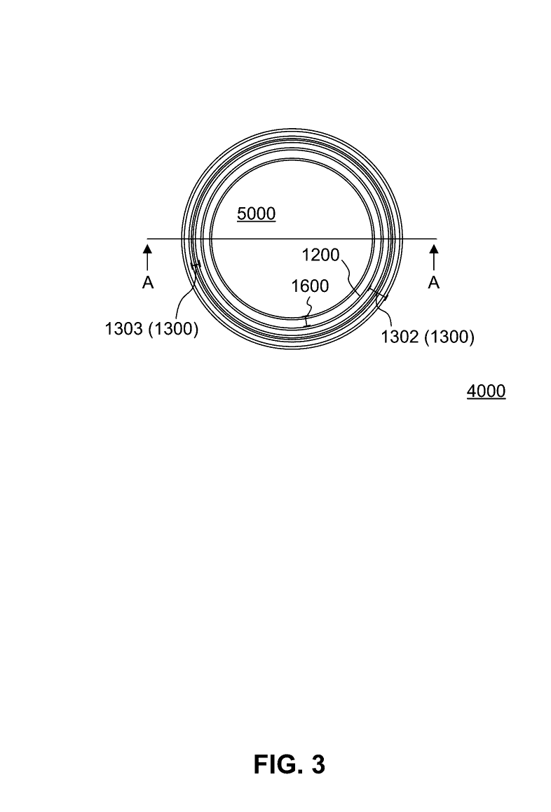

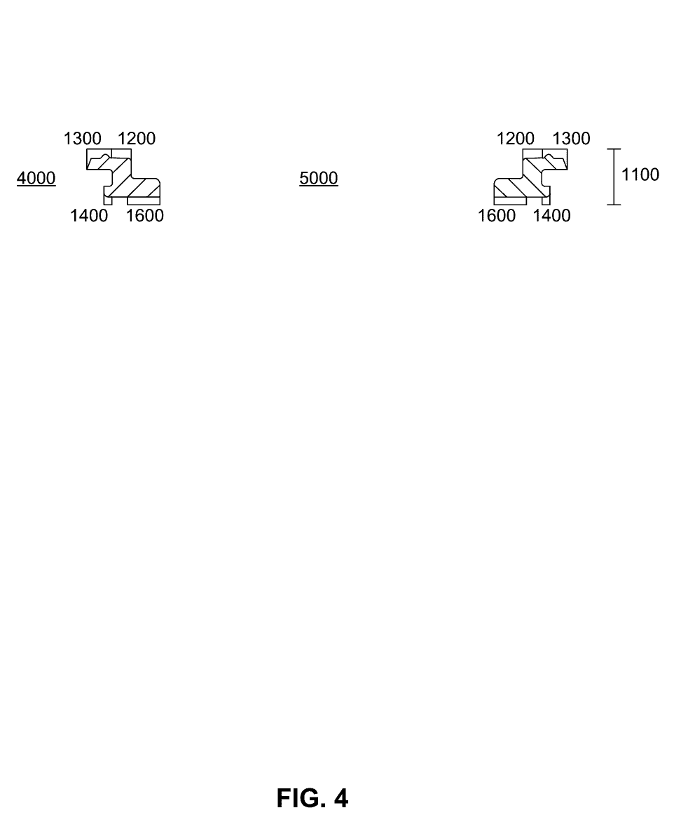

As shown in FIGS. 2A-2D, container 1000 includes neck portion 1001 comprising a neck finish 1100. A top view of neck finish 1100 is shown in FIG. 3. A cross-sectional view of neck finish 1100 at line A-A of FIG. 3 is shown in FIG. 4. For clarity, only neck finish 1100 is shown in FIGS. 3 and 4.

As shown in FIG. 3, in some embodiments, neck finish 1100 has a horizontal cross-section that is generally circular. However, other horizontal cross-sectional shapes are envisioned, including but not limited to polygons such as rectangular cross-sections.

As shown in FIGS. 2A-2D and 4, neck finish 1100 comprises a sidewall 1200. A top flange 1300 projects from sidewall 1200 in a first direction. A bottom flange 1400 also projects from the sidewall 1200 in the first direction. In some embodiments, the first direction is towards an exterior 4000 of container 1000. In embodiments where neck finish 1100 has a generally circular horizontal cross-sectional shape, sidewall 1200 is a cylindrical sidewall, as shown in FIG. 3.

Neck portion 1001 may also include threads (not shown) that allow for the screwing of a cap onto neck portion 1001. In some embodiments, the threads may be located in neck portion 1001 below bottom flange 1400. In some embodiments, the threads may be located in neck finish 1100 between top flange 1300 and bottom flange 1400 as long as the threads do not interfere with the interaction between a blow-mold gripper and a gap 1500 between top flange 1300 and bottom flange 1400, as will be described below. In some embodiments, threads may be located on shoulder portion 1002 or body portion 1003. In some embodiments, container 1000 does not have any threads.

As shown in FIG. 3 and FIGS. 2A-2D, top flange 1300 extends circumferentially around sidewall 1200. Bottom flange 1400 also extends circumferentially around sidewall 1200. This is shown in FIGS. 2A-2D (bottom flange 130 is not visible in FIG. 3).

Top flange 1300 and bottom flange 1400 are structurally different from threads that may be present on sidewall 1200. For example, one way to characterize top flange 1300 and bottom flange 1400 is that they encircle the circumference of sidewall 1200 without any axial displacement along sidewall 1200. Another way to characterize top flange 1300 and bottom flange 1400 is that top flange 1300 extends circumferentially around sidewall 1200 such that it connects to itself and bottom flange 1400 extends circumferentially around sidewall 1200 such that it connects to itself. The self-connection of top flange 1300 and bottom flange 1400 are shown in FIGS. 2A, 2B, 2C, and 2D, which show the front side view, back side view, left side view, and right side view of the neck finish 1100, respectively.

Yet another way to characterize top flange 1300 and bottom flange 1400 is that they extend non-helically around the circumference of sidewall 1200. This may mean that both top flange 1300 and the bottom flange 1400 do not have a lead advance (no axial displacement) as they rotate 360° around sidewall 1200. The absence of a lead advance indicates that the lead angle of top flange 1300 and the lead angle of bottom flange 1400 are both 0° and the helix angle of top flange 1300 and the helix angle of bottom flange 1400 are both 90°. Lead angle L and helix angle H of a structure with an axial advance or displacement are shown in a schematic representation in FIG. 2E. Top flange 1300 may also be characterized in that it remains generally on the same horizontal plane as it extends around the circumference of sidewall 1200. Bottom flange 1400 may also be characterized in that it remains on the same general plane as it extends around the circumference of sidewall 1200. These characteristics of top flange 1300 and bottom flange 1400 make them structurally different from threads that may be included in container 1000. For example, threads located on sidewall 1200 may have a lead advance as they rotate 360° around sidewall 1200.

Ways in which the structure of neck finish 1100 allows for compatibility with the blow-mold process while remaining lightweight will now be discussed in reference to FIGS. 2A-2D, 5A-5C, 6, and 10A-10B.

One feature of neck finish 1100 that contributes to the compatibility with the blow-mold process is the placement of top flange 1300 and bottom flange 1400 along sidewall 1200 and the relative distance between two flanges.

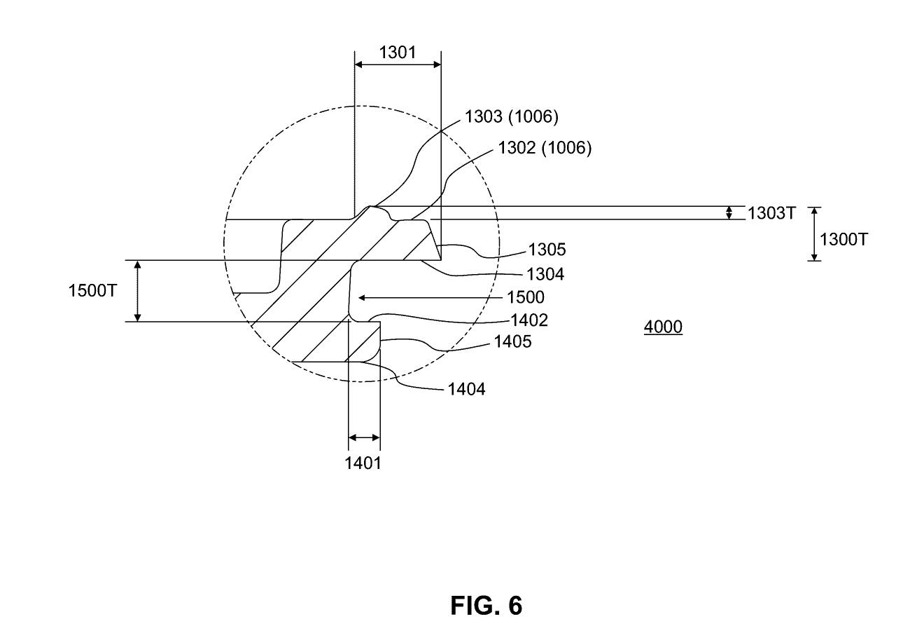

Bottom flange 1400 is vertically spaced apart from top flange 1300 on sidewall 1200 such that gap 1500 is formed between top flange 1300 and bottom flange 1400. This may be seen in FIGS. 2A-2D and 6. In some embodiments, and as shown in FIGS. 2A-2D, gap 1500 extends circumferentially around sidewall 1200 like top flange 1300 and bottom flange 1400.

In some embodiments, and as shown in FIG. 6, top flange 1300 has a top surface 1302, a side surface 1305, and a bottom surface 1304. As also shown in FIG. 6, bottom flange 1400 has a top surface 1402, a side surface 1405, and a bottom surface 1404. In some embodiments, gap 1500 spans between bottom surface 1304 of top flange 1300 and top surface 1402 of bottom flange 1400 and has a thickness 1500T. Additionally, in some embodiments, gap 1500 and thickness 1500T remain constant around the circumference of the sidewall 1200. This may mean that thickness 1500T does not change around the circumference of sidewall 1200.

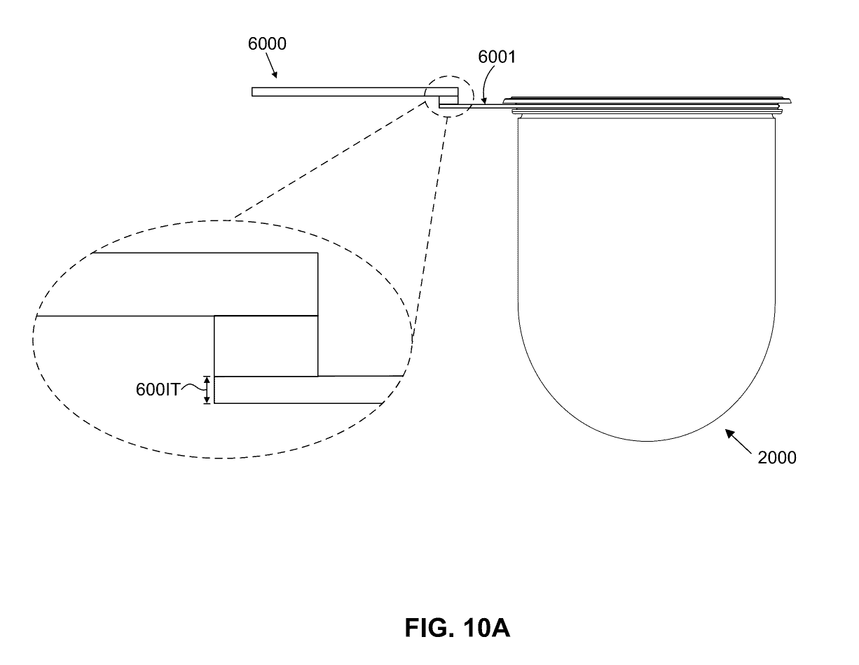

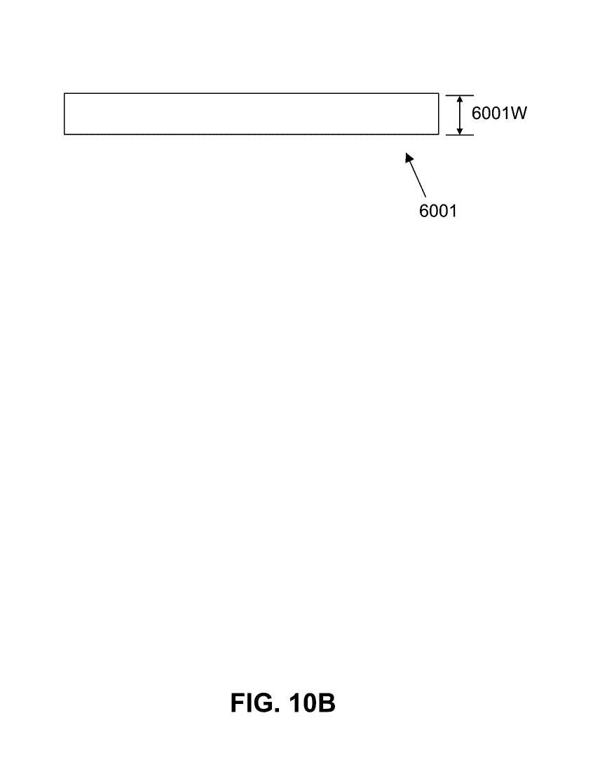

When configured in this manner, gap 1500 may accommodate a gripper 6001 with thickness 6001T of a blow-mold machine 6000 (shown in FIG. 10A). Thickness 1500T of gap 1500 may vary depending on the specific blow-mold machines that are used and the thickness of gripper 6001. One skilled in the art, with the benefit of this disclosure, may be able to determine the appropriate thickness 1500T. In some embodiments, however, the gap spans at least 1.5 millimeters (e.g. between 1.5 and 5 millimeters, or between 1.5 and 10 millimeters). This may be described as the gap 1500 having a thickness 1500T of at least 1.5 millimeters and at most 10 millimeters.

Additionally, in some embodiments, bottom flange 1400 may also act as a support ledge, allowing neck finish 1100 to rest on top of a mold that is used to form the final container shape.

Another feature of neck finish 1100 that contributes to the compatibility with the blow-mold process is the relationship between the projection distance of the top flange 1300 and bottom flange 1400.

As shown in FIG. 6, top flange 1300 projects from sidewall 1200 in the first direction (towards an exterior 4000 of the container 1000) by a first distance 1301 and bottom flange 1400 projects from sidewall 1200 in the first direction by a second distance 1401 that is less than the first distance 1301. The difference between first distance 1301 and second distance 1401 may vary depending on the specific blow-mold machine that is used. A top view of one arm of gripper 6001 is shown in FIG. 10B, with one arm of gripper 6001 having width 6001W. The difference between the first distance 1301 and second distance 1401 should be such that gap 1500 may accommodate for width 6001W of gripper 6001. In some embodiments, and as shown in the Figures, first distance 1301 is longer than the second distance 1401. However, in some embodiments, second distance 1401 may be longer than first distance 1301. One skilled in the art, with the benefit of this disclosure, may be able to determine the difference to use. In some embodiments, however, first distance 1301 is longer than second distance 1401 by at least 1.5 millimeters and at most 5 millimeters.

In some embodiments, first distance 1301 is the amount that bottom surface 1304 of top flange 1300 projects from sidewall 1200 and second distance 1401 is the amount that top surface 1402 of bottom flange 1400 projects from sidewall 1200. This is because gripper 6001 would engage the container (or preform) at gap 1500 formed between bottom surface 1304 and top surface 1402. However, in some embodiments, first distance 1301 may be determined by using an average of the length of bottom surface 1304 and top surface 1302 and second distance 1401 may be determined by using an average of the length of bottom surface 1404 and top surface 1402.

A feature that contributes to the light weight of neck finish 1100 is the side surface 1305 of top flange 1300. In some embodiments, side surface 1305 of top flange 1300 is not parallel to axis 1000N but is angled relative to axis 1000N such that side surface 1305 forms angle 1305A with axis 1000N. This is shown in FIG. 5A. The angled slope of side surface 1305 allows for less material to be used in top flange 1300, amounting to a decrease in the raw material needed for neck finish 1100.

Changing angle 1305A affects the thickness 1300T of top flange 1300. For example, increasing angle 1305A may lead to a decrease in thickness 1300T of top flange 1300, as shown in FIGS. 5B and FIG. 5C, exaggerated for clarity. While this may lead to a smaller amount of raw material for top flange 1300, the decreased thickness 1300T of top flange 1300 may also lead to decreased stability of top flange 1300, which may be a factor to consider in certain methods of closing container 1000. One skilled in the art, with the benefit of this disclosure, could determine an appropriate angle 1305A depending on the packaging needs of the product to be stored. In one embodiment, however, angle 1305A is at least 18°.

In some embodiments, sidewall 1200 has an outer surface 1201 and an inner surface 1202. As shown in FIG. 5, outer surface 1201 of sidewall 1200 may not be not parallel to axis 1000N. An angle formed between outer surface 1201 of sidewall 1200 and axis 1000N is 1200A. In some embodiments this angle is less than 3°.

In some embodiments, and as shown in FIG. 4, neck finish 1100 also comprises a base 1600 that projects from sidewall 1200 in a second direction. In some embodiments, second direction is different from first direction and is directed towards an interior 5000 of container 1000. Base 1600 extends from sidewall 1200 by a third distance 1601, as shown in FIG. 5A. In some embodiments, third distance 1601 is longer than second distance 1401 (distance that bottom flange 1400 extends from sidewall 1200). In some embodiments, at least one surface of bottom flange 1400 and at least one surface of base 1600 are coplanar. This may be seen in FIG. 4, where bottom surface 1404 of bottom flange 1400 and bottom surface (not labeled) of base 1600 are coplanar with one another. In some embodiments, base 1600 has a thickness 1600T, shown in FIG. 5A.

The arrangement of the neck finish 1100 as described herein, specifically the structure and location of top flange 1300 and bottom flange 1400, allows for a simpler and more convenient handling in the overall process cycle of the blow-molding manufacturing of container 1000. The arrangement allows for the amount of material used in neck finish 1100 to be of sufficient size so that container 1000 or preform may support a gripper of a blow-molding machine between top flange 1300 and bottom flange 1400. At the same time, the arrangement also allows for a limited amount of raw material to be used to form the neck finish 1100, resulting in neck finish 1100 that lightweight. In some embodiments, the weight of the material comprising neck finish 1100 may only have a weight of 3 grams. In some embodiments, the weight may only have a weight of 2.5 grams. In some embodiments, the weight may only be 2.2 grams.

In some embodiments, neck finish 1100 also includes structures that contribute to effective hermetic storage of the consumable product. For example, neck finish 1100 may be configured to allow for the attachment of a simple foil seal and/or a snap-on cap.

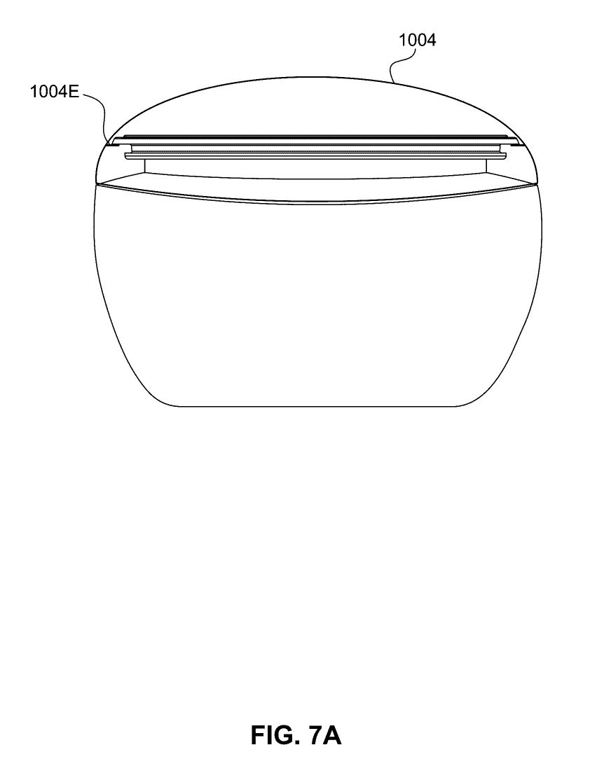

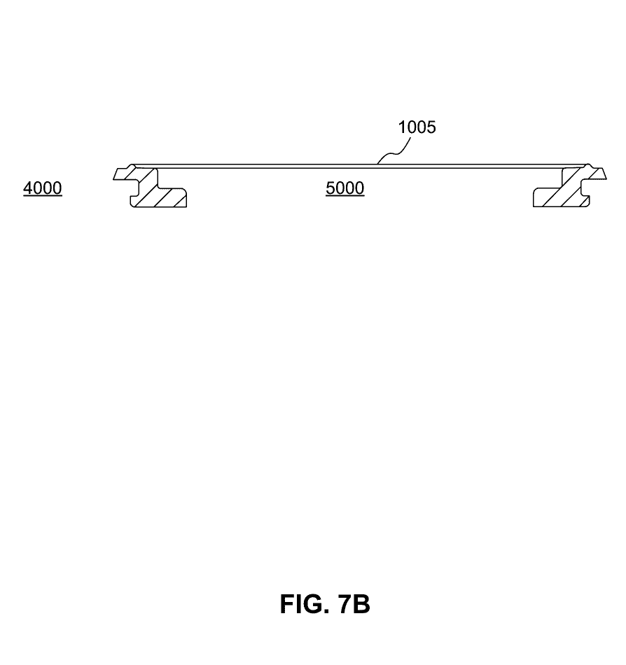

In some embodiments, the projection of top flange 1300 by first distance 1301 allows for top flange 1300 to interact with an engagement portion 1004E of a cap 1004, as shown in FIG. 7A. This engagement portion 1004E allows cap 1004 to snap-on to neck portion 1001 by engaging with the engagement of engagement portion 1004E with top flange 1300. Cap 1004 is shown in FIG. 7A as being transparent so that engagement portion 1004E and other features of the neck finish 1100 may be seen. In some embodiments, cap 1004 is not transparent.

In some embodiments, top surface 1302 may include a circular raised portion 1303.

This is seen in FIG. 6. In some embodiments, circular raised portion 1303 is formed by an upwards projection of the top surface 1302. In some embodiments, raised portion 1303 extends for the circumference of top surface 1302. This is shown in FIG. 3. Circular raised portion 1303 has a thickness 1303T, shown in FIG. 5A. Thickness 1301T allows for the attachment of a seal 1005 to raised portion. Seal 1005 is breakable to allow access to the contents of container 1000. In some embodiments, container 1000 may include both seal 1005 and cap 1004.

In some embodiments, top surface 1302 of top flange 1300, including raised portion 1303, when present, forms an outermost surface 1006 of container 1000. In these embodiments, no other sidewall or structure extends from top surface 1302 and top surface 1302 is the surface that interacts directly with exterior 4000 of container 1000 in the absence of a cap 1004.

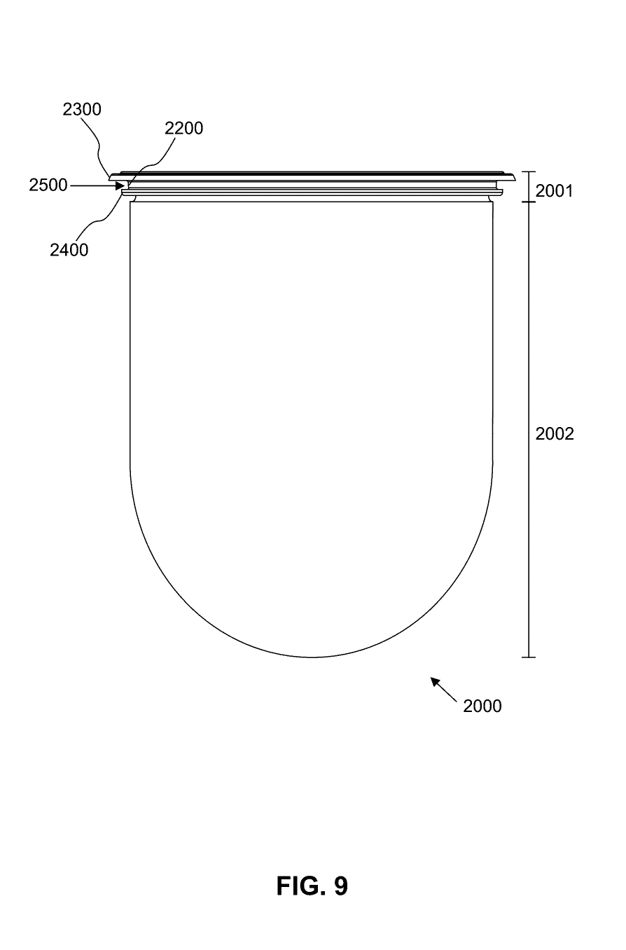

The preform used to create container 1000 will now be discussed in relation to FIGS. 9 and 10A-10B.

Preform 2000 includes moldable body 2002 and neck portion 2001. Moldable body 2002 may be comprised of a similar material as container 1000, including, but not limited to PET (polyethylene terephthalate), but other suitable flexible and resilient materials may be used, including, but not limited to, plastics such as PEN (polyethylene naphthalate), bioplastics such as PEF (polyethylene furanoate), and other polyesters.

Neck portion 2001 comprises neck finish 2100. Neck portion 2001 and neck finish 2100 are similar to neck portion 1001 and neck finish 1100 of container 1000. Neck finish 2100 comprises sidewall 2200, top flange 2300, bottom flange 2400, and gap 2500. Sidewall 2200 is similar in composition and structure to sidewall 1200. Top flange 2300 is similar in composition and structure to top flange 1300. Bottom flange 2400 is similar in composition and structure to bottom flange 1400. Gap 2500 is similar to gap 1500. Thus, the discussion above in relation to neck portion 1001, neck finish 1100, sidewall 1200, top flange 1300, bottom flange 1400, and gap 1500 are also applicable here to neck portion 2001, neck finish 2100, sidewall 2200, top flange 2300, bottom flange 2400, and gap 2500, respectively. In some embodiments, preform also includes a base 2600, which is similar in composition and structure to base 1600. The discussion above with regards to base 1600 is applicable here to base 2600.

Preform 2000 is configured to accommodate gripper 6001 of a blow-molding machine. In some embodiments, and as shown in FIG. 10A, preform 2000 is configured to accommodate gripper 6001 between top flange 2300 and bottom flange 2400. During the blow-mold process, moldable body 2002 is bi-axially stretched using a blow-mold machine to form the body portion 1003 and shoulder portion 1002 of container 1000. Neck finish 2100 is not stretched, thus the structure of the neck finish 2100 of preform 2000 is similar to the structure of neck finish 1100 in container 1000.

The present invention has been described above with the aid of functional building blocks illustrating the implementation of specified functions and relationships thereof. The boundaries of these functional building blocks have been defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

Further, references herein to “some embodiments,” “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

What is claimed is:

1. A container comprising:
a cylindrical sidewall;
a top flange projecting from the sidewall in a first direction by a first distance, wherein the top flange extends circumferentially around the sidewall;
a bottom flange projecting from the sidewall in the first direction by a second distance that is less than the first distance, wherein the bottom flange extends circumferentially around the sidewall; and
a gap between the top flange and the bottom flange.

2. The container of claim 1, wherein the top flange comprises a bottom surface,
wherein the bottom flange comprises a top surface, and
wherein the gap is formed between the bottom surface of the top flange and the top surface of the bottom flange.

3. The container of claim 2, wherein the gap spans at least 1.5 millimeters.

4. The container of claim 1, wherein the gap extends circumferentially around the sidewall

5. The container of claim 1, wherein the difference between the first distance and the second distance is at least 1.5 millimeters.

6. The container of claim 1, wherein the top flange comprises a top surface that forms an outermost surface of the container.

7. The container of claim 6, wherein the top surface includes a circular raised portion formed by an upwards projection of the top surface.

8. The container of claim 1, wherein the container does not comprise threads.

9. The container of claim 1, wherein the first direction is towards an exterior of the container.

10. The container of claim 9, further comprising a base projecting from the sidewall in a second direction, wherein the second direction is towards an interior of the container.

11. The container of claim 10, wherein the base extends further from the sidewall than the bottom flange.

12. The container of claim 10, wherein the bottom flange and the base are coplanar.

13. The container of claim 10, wherein the material forming the sidewall, the top flange, the bottom flange, and the base weighs less than 3 grams.

14. The container of claim 10, wherein the material forming the sidewall, the top flange, the bottom flange, and the base weighs less than 2.5 grams.

15. The container of claim 1, wherein the gap between the top flange and the bottom flange remains constant around the circumference of the sidewall.

16. The container of claim 1, further comprising:
a body portion;
a shoulder portion connected to the body portion; and
a neck portion extending from the shoulder portion, wherein the neck portion comprises:
the cylindrical sidewall;
the top flange;
the bottom flange; and
the gap.

17. The container of claim 16, wherein the container further comprises a cap disposed over the neck portion, the cap comprising an engagement portion to engage with the top flange.

18. The container of claim 16, the top flange includes a top surface comprising a circular raised portion, and wherein the container further comprises a seal attached to circular raised portion.

19. The container of claim 16, wherein the container is a bottle.

20. The container of claim 16, wherein the container is a cartridge for holding a beverage ingredient.

21. A preform comprising:
a moldable body portion; and
a neck portion, wherein the neck portion comprises:
a cylindrical sidewall;
a top flange extending from the sidewall, wherein the top flange extends circumferentially around the sidewall;
a bottom flange extending from the sidewall, wherein the bottom flange extends circumferentially around the sidewall; and
a gap between the top flange and the bottom flange.

22. The preform of claim 21, wherein the preform is configured to accommodate a gripper of a blow-molding machine between the top flange and the bottom flange.
